(19) United States
(12) Patent Application Publication
(10) Pub. No.: US 2026/0257095 A1
(43) Pub. Date: Sep. 3, 2026

(54) GLYCOL-FREE FIRE-FIGHTING COMPOSITION

(71) Applicant: Tyco Fire Products LP, Cranston, RI (US)

(72) Inventors: JoAnna M. Monfils, Peshtigo, WI (US); John P. Libal, Peshtigo, WI (US)

(73) Assignee: Tyco Fire Products LP, Cranston, RI (US)

(21) Appl. No.: 18/291,157

(22) PCT Filed: Oct. 18, 2022
(86) PCT No.: PCT/IB2022/060015

§ 371 Date: Jan. 22, 2024

Related U.S. Application Data
(60) Provisional application No. 63/272,247, filed on Oct. 27, 2021.

(51) Int. Cl. A62D 1/02

(52) U.S. Cl. CPC A62D 1/0071

(57) ABSTRACT

An aqueous fire-fighting composition includes a sugar component, a surfactant component, an alkanolamine, and a polysaccharide thickener. The composition is substantially free of any glycol-type solvent and fluorinated additives. The compositions may be used in methods of forming a firefighting foam and fighting a fire with the firefighting foam.

### CROSS-REFERENCE TO RELATED APPLICATIONS

This application is claims the benefit of priority to U.S. Provisional Patent Application No. 63/272,247, filed on Oct. 27, 2021, the contents of which are incorporated herein by reference in their entirety.

### BACKGROUND

Firefighting foams are often able to fight Class A and Class B fires. Class A fires are those involving combustible material such as paper, wood, etc. and can be fought by quenching and cooling with large quantities of water or solutions containing water. Class B fires are those involving flammable liquid fuels, gasoline, and other hydrocarbons and are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling.

Conventional foam-forming firefighting compositions commonly include fluorinated and perfluorinated surfactants. Environmental concerns related to fluorinated and perfluorinated surfactants have developed. As a result, there is a strong desire in the marketplace to replace fluorinated and perfluorinated firefighting products with nonfluorinated products. There is therefore a continuing need to produce fluorine-free AFFF firefighting compositions that can be deployed to fight Class A and Class B fires.

### SUMMARY

The present application is directed to aqueous fire-fighting foam compositions, typically in concentrated form, which can be diluted with an aqueous diluent to provide a foam precursor composition. The more dilute foam precursor composition may be aerated to form a firefighting foam. The aqueous fire-fighting composition includes a sugar component, a surfactant component, an alkanolamine, and polysaccharide thickener and does not contain any substantial amount of a glycol-type solvent. For example, the aqueous fire-fighting composition may include a sugar component, anionic surfactant, zwitterionic surfactant, nonionic surfactant, an alkanolamine, and polysaccharide thickener. The application also provides a method of fighting a fire with the firefighting foam.

The present aqueous firefighting compositions typically include a sugar component substantially in the form of a monosaccharide sugar and/or a sugar alcohol; together with a surfactant component containing nonionic surfactant, anionic surfactant and/or zwitterionic surfactant. The surfactant component commonly is substantially free of and, often, does not contain any glycol-type solvent. The composition may desirably be substantially free of any fluorinated additive, e.g., contain no more than 0.1 wt. % and preferably no more than 0.01 wt. % fluorinated additive(s) and, often, is completely free of any fluorinated surfactant or other fluorinated additive. In some instances, the composition may have a total concentration of fluorine atoms on a weight percentage basis of no more than about 1 ppm F.

An exemplary embodiment provides an aqueous firefighting composition including a sugar component, which includes monosaccharide sugar and/or sugar alcohol; a surfactant mixture containing a zwitterionic surfactant, aliphatic alcohol-based surfactant, and one or more of alkyl sulfate anionic surfactant, alkyl sulfonate anionic surfactant and alkyl ether sulfate anionic surfactant; alkanolamine; and polysaccharide thickener. An aqueous firefighting foam precursor can be formed by diluting the more concentrated aqueous firefighting composition with a much larger volume of an aqueous diluent, e.g., municipal water, brackish water and/or salt water. The resulting firefighting foam precursor can then be aerated to provide a firefighting foam.

In another exemplary embodiment, the aqueous firefighting foam composition includes a sugar component; polysaccharide thickener; a surfactant component, which comprises one or more of an anionic surfactant, a zwitterionic surfactant and a nonionic surfactant; and alkanolamine. The aqueous firefighting composition commonly includes at least about 30 wt. % water and is substantially free of any glycol ether, alkylene glycol, and water-soluble polyalkylene glycol solvents. In many instances, the composition contains a total of no more than 0.5 wt. % and, preferably no more than 0.1 wt. % glycol ether, alkylene glycol, and water-soluble polyalkylene glycol solvents. Often, the sugar component comprises monosaccharide sugar and/or sugar alcohol, e.g., at least about 75 wt. % and, in many instances, at least about 85 wt. % monosaccharide sugar and/or sugar alcohol. The surfactant component very often includes a combination of (a) alkyl sulfate anionic surfactant, (b) alkylamidoalkyl hydroxysultaine and (c) an aliphatic alcohol-based component. In some instances, the composition may also include a small amount (e.g., up to about 1 wt. %) of glycerin. The composition generally contains no more than 0.1 wt. % or no more than 0.01 wt. % fluorinated additive(s) and, often, is completely free of any fluorinated surfactant(s).

In another exemplary embodiment, the aqueous firefighting foam composition includes at least about 5 wt. % of a sugar component; polysaccharide thickener; a surfactant component, which includes aliphatic anionic surfactant, zwitterionic surfactant, and an aliphatic alcohol-based component; at least about 3 wt. % alkanolamine; and at least about 40 wt. % water. The sugar component includes at least about 75 wt. % and, often, at least about 85 wt. % monosaccharide sugar and/or sugar alcohol. Commonly, the aqueous firefighting composition is substantially free of any glycol ether, alkylene glycol, and water-soluble polyalkylene glycol solvents. The composition generally contains no more than 0.1 wt. % or no more than 0.01 wt. % fluorinated additive(s) and, often, is completely free of any fluorinated surfactant(s) or other fluorinated additive(s).

Another exemplary embodiment provides an aqueous firefighting foam composition including includes about 10 to 20 wt. % of a monosaccharide sugar and/or sugar alcohol; about 0.5 to 3 wt. % polysaccharide thickener, which comprises xanthan gum, rhamsan gum and/or diutan gum; about 5 to 20 wt. % of a surfactant component, which includes alkyl sulfate anionic surfactant, hydroxysultaine zwitterionic surfactant, and an aliphatic alcohol-based component; about 3 to 10 wt. % alkanolamine; and at least about 40 wt. % water. The aqueous firefighting composition typically is substantially free of any glycol ether, alkylene glycol, and water-soluble polyalkylene glycol solvents. In many instances, the composition contains a total of no more than 0.5 wt. % and, often no more than 0.1 wt. % glycol ether, alkylene glycol, and water-soluble polyalkylene glycol solvent. The composition generally contains no more than 0.1 wt. % or no more than 0.01 wt. % fluorinated additive(s) and, often, is completely free of any fluorinated surfactant(s) or other fluorinated additive(s).

In another exemplary embodiment, the aqueous firefighting foam composition includes about 10 to 20 wt. % monosaccharide sugar including glucose and/or fructose; about 0.5 to 3 wt. % polysaccharide thickener; about 3 to 10 wt. % alkyl sulfate anionic surfactant; about 1 to 10 wt. % alkylamidopropyl hydroxysultaine surfactant; about 1 to 10 wt. % fatty alcohol-based component; and about 0.3 to 3 wt. % alkanolamine. Commonly, the aqueous firefighting composition includes at least about 40 wt. % water. In most instances, polysaccharide thickener, which comprises xanthan gum, rhamsan gum and/or diutan gum. The aqueous firefighting composition contains a total of no more than 0.5 wt. %, often no more than 0.1 wt. %, glycol ether, alkylene glycol and water-soluble polyalkylene glycol solvents. The composition generally contains no more than 0.1 wt. % or no more than 0.01 wt. % fluorinated additive(s) and, often, is completely free of any fluorinated surfactant(s) or other fluorinated additive(s).

In another exemplary embodiment, the aqueous firefighting composition includes about 10 to 20 wt. % monosaccharide sugar comprising glucose and/or fructose; about 0.5 to 3 wt. % polysaccharide thickener; about 3 to 10 wt. % C₈₋₁₂-alkyl sulfate anionic surfactant; about 1 to 10 wt. % C₈₋₁₄-alkylamidopropyl hydroxysultaine; about 1 to 10 wt. % C₈₋₁₂-fatty alcohol and/or C₁₀₋₁₄-fatty alcohol ethoxylate; about 0.3 to 3 wt. % alkanolamine; and at least about 40 wt. % water. The polysaccharide thickener typically includes xanthan gum, rhamsan gum, and/or diutan gum. In most instances, polysaccharide thickener, which comprises xanthan gum, rhamsan gum and/or diutan gum. The aqueous firefighting composition contains a total of no more than 0.5 wt. %, often no more than 0.1 wt. %, glycol ether, alkylene glycol, and water-soluble polyalkylene glycol solvents. The composition generally contains no more than 0.1 wt. % or no more than 0.01 wt. % fluorinated additive(s) and, often, is completely free of any fluorinated surfactant(s) or other fluorinated additive(s).

### DETAILED DESCRIPTION

In one aspect, the aqueous firefighting foam compositions of the present disclosure include a sugar component, e.g., a monosaccharide sugar and/or sugar alcohol; polysaccharide thickener; a surfactant component, which comprises anionic surfactant, nonionic surfactant and/or zwitterionic surfactant; and alkanolamine. The composition commonly is substantially free of and, often, does not contain any glycol-type solvent. The composition may desirably be substantially free of any fluorinated additive, e.g., contain no more than 0.1 wt. % and preferably no more than 0.01 wt. % fluorinated additive(s) and, often, is completely free of any fluorinated surfactant or other fluorinated additive.

Sugars and/or sugar alcohols suitable for use in the present aqueous fire-fighting foam compositions are generally simple monosaccharide sugars or related sugar alcohols, but may include small amounts of other carbohydrates, such as common sugar (sucrose/dextrose) derived from sugar cane or sugar beets. Sucrose is a disaccharide composed from the basic, simple sugar molecules glucose and fructose. Mixtures where the majority of the sucrose has been broken down into its monosaccharide components, glucose and fructose (e.g., invert sugar), are quite suitable for use in the present compositions. Quite commonly, the sugar component may contain at least about 75 wt. %, or more preferably at least 85 wt. % monosaccharide sugars and/or sugar alcohols. Often, the sugar component suitably contains at least about 75 wt. %, or more preferably at least about 85 wt. % monosaccharide sugars, such as glucose and/or fructose. The sugar component typically contains a total of no more than about 10 wt. % and, often no more than about 5 wt. % disaccharide sugars and oligosaccharides (as a percentage of the total weight of the sugar component).

Sucrose is readily available in view of its world production from sugar cane and sugar beets on the order of millions of tons per annum. Those skilled in the art will also understand that other commercially available simple monosaccharides and related sugar alcohols can be utilized in the present foam compositions. Examples of suitable monosaccharides for use in the present foam compositions include one or more of glucose, fructose, mannose, xylose, and galactose. Examples of suitable sugar alcohols for use in the present foam compositions include one or more of a four carbon sugar alcohol, such as erythritol, a five carbon alditol, such as xylitol, a six carbon alditol, such as mannitol and/or sorbitol, and other sugar alcohols, such as isomalt. Commonly, the sugar alcohol is one derived from a monosaccharide.

The present aqueous fire-fighting foam compositions generally include a sugar component including at least about 50 wt. %, at least about 75 wt. % and, in many instances at least about 85 wt. % of one or more monosaccharide sugars and/or sugar alcohols. Suitable examples include such a sugar component containing one or more of glucose, fructose, mannose, xylose, sorbitol, xylitol, and mannitol. The foam composition commonly includes about 5 to 25 wt. % and, more commonly about 5 to 20 wt. % of the sugar component. In some instances, the foam composition may include about 10 wt. % to 15 wt. % of the sugar component. In some embodiments, the sugar component comprises at least about 75 wt. %, at least about 80 wt. %, or even at least about 90 wt. % monosaccharide sugar and/or sugar alcohol. For example, the sugar component may comprise at least about 75 wt. %, at least about 80 wt. %, at least about 85 wt. %, or even at least about 90 wt. % of one or more of glucose, fructose, mannose, xylitol, sorbitol, and mannitol. In some embodiments, the foam composition may include a sugar component, which comprises at least about 75 wt. % of one or more sugar alcohols, such as xylitol, sorbitol, and mannitol. Advantageously, the sugar component may include at least about 75 wt. %, at least about 80 wt. %, at least about 85 wt. %, or even at least about 90 wt. % of one or more of glucose, fructose, and sorbitol. For example, the sugar component may include at least about 75 wt. % and, more commonly, at least about 85 wt. % glucose and/or fructose.

The present aqueous fire-fighting foam compositions typically include an anionic surfactant. The anionic surfactant may suitably include an aliphatic sulfate surfactant, an aliphatic sulfonate surfactant, aliphatic ether sulfate surfactant, and/or an aliphatic ether sulfonate surfactant. The anionic surfactant may suitably include an alkyl sulfate surfactant, an alkyl sulfonate surfactant, alkyl ether sulfate surfactant and/or an alkyl ether sulfonate surfactant. The anionic surfactant typically includes an alkyl sulfate surfactant and/or an alkyl sulfonate surfactant. The alkyl sulfate salt surfactant typically includes include a C₈₋₁₂-alkyl sulfate salt. Suitable examples of the C₈₋₁₂-alkyl sulfate salt include a dodecyl sulfate salt (lauryl sulfate salt), a decyl sulfate salt, an octyl sulfate salt, or a combination of any two or more thereof. In some embodiments, the alkyl sulfate salt includes an alkyl sulfate sodium salt, such as a sodium decyl sulfate, sodium octyl sulfate, or a combination thereof. In some embodiments, the alkyl sulfate salt includes an alkyl sulfate ammonium salt, such as an ammonium decyl sulfate, ammonium octyl sulfate, ammonium lauryl sulfate, triethanolamine lauryl sulfate salt, or a combination thereof. In embodiments that include the anionic surfactant, the aqueous firefighting foam composition may include about 1 to 25 wt. % or about 2 to 20 wt. % of the anionic surfactant. Typically, the aqueous firefighting foam composition commonly includes about 3 to 15 wt. %, about 5 to 12 wt. % and, in some instances, about 5 to 10 wt. % of a the anionic surfactant.

In some embodiments, the aqueous fire-fighting foam composition may include an anionic surfactant comprises a C₈₋₁₄-alkyl sulfate salt and/or a C₈₋₁₄-alkyl sulfonate salt. In some embodiments, the aqueous fire-fighting foam composition may include an anionic surfactant, which comprises one or more surfactants selected from C₈₋₁₂-alkyl sulfate salts and/or a C₈₋₁₂-alkyl sulfonate salts. For example, one or more of octyl sulfate salts, decyl sulfate salts, dodecyl sulfate salts, and tetradecyl sulfate salts may be suitable for use as anionic surfactants in the present foam composition. The anionic surfactant may suitably be a sodium, potassium, and/or ammonium salt (e.g., an NH₄+ or trialkyl ammonium salt).

In some embodiments, the aqueous fire-fighting foam composition may include an anionic surfactant comprising a C₈₋₁₄-alkyl sulfate amine salt. In some embodiments, the aqueous fire-fighting foam composition may include an anionic surfactant, which comprises one or more surfactants selected from C₈₋₁₂-alkyl sulfate amine salts and/or a C₈₋₁₂-alkyl sulfonate amine salts. For example, one or more of triethanolamine octyl sulfate salts, triethanolamine decyl sulfate salts, triethanolamine dodecyl sulfate salts, and triethanolamine tetradecyl sulfate salts may be suitable for use as anionic surfactants in the present fire-fighting foam composition.

The present aqueous fire-fighting foam compositions typically include a zwitterionic surfactant. The zwitterionic surfactant typically includes one or more of an aliphatic amidoalkyl betaine surfactant, an aliphatic betaine surfactant, an aliphatic sulfobetaine surfactant and an aliphatic amidoalkylene hydroxysultaine surfactant, such as an aliphatic amidopropyl hydroxysultaine surfactant. The zwitterionic surfactant may include one or more of an alkylamidoalkyl betaine surfactant, an alkyl betaine surfactant, an alkyl sulfobetaine surfactant and an alkylamidoalkylene hydroxysultaine surfactant, such as an alkylamidopropyl hydroxysultaine surfactant. For example, the foam composition may include a zwitterionic surfactant, which comprises one or more of a C₈₋₁₈-alkylamidopropyl hydroxysultaine surfactant, a C₈₋₁₈-alkylamidopropyl betaine surfactant a C₈₋₁₈-alkyl sulfobetaine surfactant and a C₈₋₁₈-alkyl betaine surfactant. Suitable examples of the alkylamidoalkylene hydroxysultaine surfactant include a C₈₋₁₈-alkylamidopropyl hydroxysultaine surfactant, such as a cocamidopropyl hydroxysultaine surfactant, which includes a laurylamidopropyl hydroxysultaine and a myristylamidopropyl hydroxysultaine. Suitable examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine, or a myristylamidopropyl betaine. In some embodiments, the zwitterionic surfactant includes a C₈₋₁₄-alkylamidopropyl hydroxysultaine, such as a cocamidopropyl hydroxysultaine. In some embodiments, the zwitterionic surfactant includes laurylamidopropyl hydroxysultaine and/or myristylamidopropyl hydroxysultaine. In embodiments that include the zwitterionic surfactant, the aqueous firefighting foam composition commonly includes about 1 to 15 wt. % and often about 1 to 12 wt. % of the zwitterionic surfactant. In certain embodiments, the aqueous firefighting foam composition may include about 1 to 10 wt. % and, more commonly, about 2 to 7 wt. % of the zwitterionic surfactant.

The present aqueous fire-fighting foam compositions may suitably include a nonionic surfactant, such as an aliphatic alcohol-based surfactant. In one aspect, the present aqueous firefighting foam concentrates include an aliphatic alcohol-based component, such as an aliphatic alcohol and/or an aliphatic alcohol ethoxylate. For example, the concentrate may include an aliphatic alcohol-based component including an aliphatic alcohol having 8 to 14 carbon atoms or an aliphatic alcohol ethoxylate having 10 to 16 carbon atoms in its alcohol portion. Alternatively, the concentrate may include a mixture of an aliphatic alcohol having 8 to 14 carbon atoms and an aliphatic alcohol ethoxylate having 10 to 16 carbon atoms in its alcohol portion. In such mixtures, the ratio of aliphatic alcohol to aliphatic alcohol ethoxylate may be in range of about 10:1 to 1:10, or about 5:1 to 1:5, about 2:1 to 1:2, about 1.5:1 to 1:1:5, or more commonly about 1:1. The foam concentrate may suitably include about 0.1 to 5 wt. %, commonly, about 0.5 to 3 wt. % and, more commonly, about 0.5 to 2 wt. % of the aliphatic alcohol-based nonionic surfactant. The aliphatic alcohol ethoxylate commonly has an average degree of polymerization (i.e., the average number of ethylene oxide units) of about 0.5-6.0 and often of no more than about 4.0, desirably no more than about 3.0 or no more than about 2.0. Aliphatic alcohols, which include a linear C₈₋₁₄-aliphatic alcohol, such as a C₈₋₁₄-fatty alcohol, are suitable for use as a nonionic surfactant in the present concentrates. Suitable examples of such alcohols include one or more of octyl alcohol, decyl alcohol, lauryl alcohol, and myristyl alcohol. The foam concentrate may include an aliphatic alcohol ethoxylate having an average of no more than about 3 ethylene oxide units. The aliphatic alcohol portion of such ethoxylates typically has about 10 to 16 carbon atoms. Suitable examples include decyl alcohol ethoxylates, lauryl alcohol ethoxylates, myristyl alcohol ethoxylates, and/or cetyl alcohol ethoxylates. Such ethoxylates commonly have an average of no more than about 3 ethylene oxide units, no more than about 2.0 ethylene oxide units, no more than about 1.5 ethylene oxide units and, in some instances, no more than about 1 ethylene oxide units. In one suitable embodiment, the aliphatic alcohol ethoxylate comprises an ethoxylate of a linear C₈₋₁₄-aliphatic alcohol having no more than about 1.2 ethylene oxide units.

The aliphatic alcohol-based component may include an aliphatic alcohol ethoxylate. The aliphatic alcohol ethoxylate commonly has an average degree of polymerization (i.e., the average number of ethylene oxide units) of about 0.5-6.0 and often of no more than about 4.0, desirably no more than about 3.0 or no more than about 2.0. Aliphatic alcohols, which include a linear C₈₋₁₄-aliphatic alcohol, such as a C₈₋₁₄-fatty alcohol, are suitable for use as a nonionic surfactant in the present concentrates. Suitable examples of such alcohols include one or more of octyl alcohol, decyl alcohol, lauryl alcohol, and myristyl alcohol. The foam concentrate may include an aliphatic alcohol ethoxylate having an average of no more than about 3 ethylene oxide units. The aliphatic alcohol portion of such ethoxylates typically has about 10 to 16 carbon atoms. Suitable examples include decyl alcohol ethoxylates, lauryl alcohol ethoxylates, myristyl alcohol ethoxylates, and/or cetyl alcohol ethoxylates. Such ethoxylates commonly have an average of no more than about 3 ethylene oxide units, no more than about 2.0 ethylene oxide units, no more than about 1.5 ethylene oxide units and, in some instances, no more than about 1 ethylene oxide units. In one suitable embodiment, the aliphatic alcohol ethoxylate comprises an ethoxylate of a linear C₈₋₁₄-aliphatic alcohol having no more than about 1.2 ethylene oxide units.

The aliphatic alcohol-based component may suitably include at least two alcohols and/or alcohol ethoxylates. For example, the concentrate may include two or more alcohol-based compounds, such as aliphatic alcohols and/or ethoxylates of aliphatic alcohols. The aliphatic alcohol ethoxylates commonly have an average of no more than about 6 and, often no more than about 4 ethylene oxide units. In some instances, the aliphatic alcohol-based component may include at least two alcohol-based compounds such as C₈₋₁₄-aliphatic alcohols and ethoxylates of C₁₀₋₁₄-aliphatic alcohols having an average of no more than about 6 ethylene oxide units.

The present aqueous fire-fighting foam compositions does not include a substantial amount of any glycol-type solvent. As used herein, the term “glycol-type solvent” refers collectively to alkylene glycol solvents, glycol ether solvents and water-soluble alkylene glycols (e.g., polyethylene glycol solvents). The composition may desirably be substantially free of any glycol-type solvent, e.g., contain no more than 0.1 wt. % and preferably no more than 0.01 wt. % glycol-type solvent and, often, is completely free of any glycol-type solvent.

The aqueous firefighting foam composition commonly includes a thickener, such as a polysaccharide thickener. The polysaccharide thickener may include a polysaccharide that is soluble in the aqueous firefighting foam concentrate and a second polysaccharide that is less soluble or insoluble in the aqueous firefighting foam concentrate. In some embodiments, the second polysaccharide may be insoluble (and dispersed) in the aqueous firefighting concentrate but may be soluble in water alone or in solutions where the concentrate has been diluted with a much larger volume of water. In other embodiments, the concentrate may only include one or more polysaccharides that are completely soluble in the concentrate. The foam concentrate typically includes about 0.1 to 5 wt. %, about 0.2 to 4 wt. %, about 0.3 to 3 wt. % and, more commonly, about 0.5 to 3 wt. % of the polysaccharide thickener.

Examples of suitable polysaccharide thickeners which may be used in the present foam compositions include agar, sodium alginate, carrageenan, gum arabic, gum guaicum, neem gum, pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, mastic gum, spruce gum, tara gum, gellan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, and a mixture of two or more thereof.

In some embodiments, the polysaccharide thickener may include one or more of xanthan gum, diutan gum, rhamsan gum, welan, gellan gum, guar gum, konjac gum, tarn gum, and methylcellulose. In some embodiments, it may advantageous to include a mixture of xanthan gum and one or more of diutan gum, rhamsan gum, welan, gellan gum, guar gum, konjac gum, tarn gum, and methylcellulose. In other embodiments, the foam concentrate may include a mixture of xanthan gum and one or more of diutan gum, rhamsan gum, welan gum, and gellan gum as the polysaccharide thickener. In other embodiments, the foam concentrate may advantageously include one or more of xanthan gum, diutan gum, and rhamsan gum. In other embodiments, the foam concentrate may advantageously include a mixture of xanthan gum and diutan gum. In other embodiments, the foam concentrate may advantageously include a mixture of xanthan gum and konjac gum.

Polysaccharide thickeners, which include a combination of xanthan gum and diutan gum, may be particularly suitable for use in the present foam compositions. For examples, the foam composition may include about 0.1 to 4 wt. %, about 0.2 to 3 wt. % and even, about 0.2 to 2 wt. % xanthan gum. Such foam compositions may also include about 0.1 to 4 wt. %, about 0.2 to 3 wt. %, or even, about 0.2 to 2 wt. % diutan gum.

In many instances, the present aqueous firefighting foam composition may include an alkanolamine, which can act as a pH adjusting agent and/or buffer. Suitable alkanolamines include monoalkanolamines, dialkanolamines, and trialkanolamines, such as monoethanolamine, diethanolamine, diisopropanolamine, and/or triethanolamine. Quite commonly, the present compositions may include triethanolamine. The triethanolamine may be present in only a relatively small amount, e.g., about 0.1 to 0.3 wt. % when included primarily as a pH adjusting agent. In other instances, the alkanolamine may be present in a higher amount, whether introduced per se as an ingredient and/or in the form of a cation as part of one of the surfactants present in the composition (e.g., as a trialkanolamine salt of an alkyl sulfate surfactant). In such instances, an alkanolamine, such as triethanolamine, may suitably be present as about 0.1 to 15 wt. %, about 2 to 15 wt. %, about 3 to 10 wt. %, and in some instances, about 4 to 8 wt. % of the composition.

As discussed above, the aqueous firefighting foam composition includes water. In some embodiments, the water is water from a municipal water source (e.g., tap water). In some embodiments, the water is a purified water, such as purified water that meets the standards set forth in the United States Pharmacopeia, which is incorporated by reference herein in relevant part. In some embodiments, the aqueous firefighting foam composition includes at least about 30 wt. % water, often at least about 40 wt. % water and, more commonly, at least about 50 wt. % water. In some embodiments, the aqueous firefighting foam composition includes greater than about 60 wt. % water. In some embodiments, the aqueous firefighting foam composition may be produced using a source of water that has a total concentration of fluorine atoms on a weight percentage basis of no more than about 1 ppm F.

The aqueous firefighting foam compositions of the present disclosure are commonly substantially free of any fluorinated additives. As used herein, the “phrase substantially free of fluorinated additives” means that the aqueous firefighting foam composition includes no more than 0.01 wt. % of fluorinated additives. In some embodiments, the aqueous firefighting foam composition includes no more than 0.005 wt. % of fluorinated additives. The aqueous firefighting foam compositions of the present disclosure are substantially free of fluorine. As used herein, the phrase “substantially free of fluorine” means that the composition has a total concentration of fluorine atoms on a weight percentage basis of no more than about 1 part per million (ppm) F. The aqueous firefighting foam compositions of the present disclosure preferably include substantially less than 1 ppm F.

In some embodiments, the aqueous firefighting foam composition includes one or more chelators or sequestering buffers. Exemplary and non-limiting chelators and sequestering buffers include agents that sequester and chelate metal ions, including polyamminopolycarboxylic acids, ethylenediaminetetraacetic acid, citric acid, tartaric acid, nitrilotriacetic acid, hydroxyethylethylenediaminetriacetic acid, and salts thereof. Exemplary buffers include Sorensen's phosphate or Mellvaine's citrate buffers.

In some embodiments, the aqueous firefighting foam composition includes one or more corrosion inhibitors. Exemplary and non-limiting corrosion inhibitors includes ortho-phenylphenol, tolyltriazole, and phosphate ester acids. In some embodiments, the corrosion inhibitor is tolyltriazole.

In some embodiments, the aqueous firefighting foam concentrate may also include a metallic salt, typically a metallic salt which includes a multi-valent cation. For example, suitable salts may include a cation selected from the group consisting of aluminum, calcium, copper, iron, magnesium, potassium, and calcium cations. The counteranion may suitably be a sulfate and/or phosphate anion. In one embodiment, the metallic salt may include a divalent salt, e.g., a magnesium salt, such as magnesium sulfate. When included, a divalent salt, such as magnesium sulfate, may suitably be present as about 0.1 to 5 wt. %, about 0.2 to 3 wt. %, about 0.5 to 3 wt. % and in some instances, about 0.5 to 2 wt. % of the composition.

In some embodiments, the aqueous firefighting foam concentrate may also include a preservative, such as one or more antimicrobial additives and/or biocidal additives. These components are included to prevent the biological decomposition of natural product based polymers that are incorporated as polymeric film formers (e.g., a polysaccharide gum). Examples include Kathon CG/ICP (Rohm & Haas Company), Givgard G-4 40 (Givaudan, Inc.), Dowicil 75 and Dowacide A (Dow Chemical Company). In some instances, the biocidal agent in the present composition may include a phenol-based biocide, such as Dowacide A (sodium o-phenylphenate).

Tables 1 to 4 below provide an illustration of suitable formulations of the present firefighting foam compositions designed to be combined with a diluent, then aerated and administered to fight a fire in the form of a firefighting foam.

TABLE 1

| Ingredient | Amount (wt. %) |
|---|---|
| Biocide | 0-0.2 |
| Corrosion inhibitor | 0-0.2 |
| Nonionic surfactant | 0.5-5 |
| Zwitterionic surfactant | 2-15 |
| Anionic surfactant | 3-15 |
| Alkanolamine | 2-15 |
| Divalent metal salt | 0-5 |
| Polysaccharide thickener | 0.1-5 |
| Monosaccharide sugar(s) and/or | 5-25 |
| sugar alcohol(s) | |
| Water | 30-80 |

TABLE 2

| Ingredient (wt. %) | Base Formula |
|---|---|
| Biocide | 0-1.0 |
| Corrosion inhibitor | 0-0.1 |
| Magnesium salt | 0-5 |
| Alkanolamine | 3-10 |
| Aliphatic anionic surfactant | 3-15 |
| Aliphatic zwitterionic surfactant | 2-15 |
| Aliphatic nonionic surfactant | 0.2-5 |
| Polysaccharide gum | 0.3-4 |
| Sugar component | 5-25 |
| Water (Balance) | ≥40 |

TABLE 3

| Ingredient | Amount (wt. %) |
|---|---|
| Biocide | 0-1.0 |
| Corrosion inhibitor | 0-0.1 |
| Magnesium sulfate | 0.2-3 |
| Triethanolamine | 3-10 |
| Alkyl sulfate anionic surfactant | 3-10 |
| Alkylamidopropyl hydroxysultaine | 2-10 |
| Fatty alcohol and/or Fatty alcohol | 0.3-3 |
| ethoxylate | |
| Xanthan and/or diutan gum | 0.5-3 |
| Glucose and/or fructose | 10-15 |
| Water (Balance) | ≥50 |

TABLE 4

| Ingredient | Amount (wt. %) |
|---|---|
| Biocide | 0-0.5 |
| Corrosion inhibitor | 0-0.1 |
| Magnesium sulfate | 0.2-3 |
| Triethanolamine | 3-10 |
| C₈₋₁₂-Alkyl sulfate anionic surfactant | 3-10 |
| C₈₋₁₄-alkylamidopropyl hydroxysultaine | 1-10 |
| C₈₋₁₂-fatty alcohol and/or | 0.3-3 |
| C₁₀₋₁₄-fatty alcohol ethoxylate | |
| Xanthan and/or diutan gum | 0.5-3 |
| Glucose and/or fructose | 10-20 |
| Water (Balance) | ≥50 |

### Examples

The following examples more specifically illustrate formulations for preparing aqueous firefighting compositions according to various embodiments described above. These examples should in no way be construed as limiting the scope of the present technology.

Tables 5 and 6 below shows the composition of a number of exemplary formulations of the present aqueous firefighting foam composition. The amounts shown in these tables represent the weight percentage of the particular component based on the total weight of the composition. The formulations include a) a surfactant mixture including an alkyl sulfate anionic surfactant, a fatty alcohol and a hydroxysultaine zwitterionic surfactant, b) a sugar component, c) an alkanolamine, d) a minor amount of glycerin, e) a substantial amount of water; f) polysaccharide thickener. The exemplary formulations shown in Table 5 do not contain any glycol-type solvent, such as a glycol ether, alkylene glycol, or water-soluble polyalkylene glycol. These exemplary formulations also include a divalent metal, such as a magnesium salt (e.g., magnesium sulfate). These exemplary formulations may also include a preservative, an antimicrobial, and/or a corrosion inhibitor, though these ingredients are considered optional, and are not key to the composition functioning as a fire-fighting agent.

TABLE 5

| Ingredient | Wt. % | Wt. % | Wt. % | Wt. % |
|---|---|---|---|---|
| Biocide | 0-0.5 | 0.1 | 0.1 | 0.1 |
| Corrosion inhibitor | 0-0.1 | 0.05 | 0.05 | 0.05 |
| Magnesium sulfate | 0.2-3 | 1 | 1.25 | 0.75 |
| Triethanolamine* (TEA) | 3-8 | 5 | 6 | 5 |
| Glycerin | 0-1 | 0.4 | 0.5 | 0.3 |
| Na Octyl (C₈) sulfate anionic | 3-4 | 3 | 2 | 3.5 |
| surfactant | | | | |
| TEA Lauryl (C₁₂) sulfate | 3-4 | 3 | 2 | 3.5 |
| anionic surfactant | | | | |
| Cocamidopropyl | 2-6 | 4 | 5 | 3 |
| hydroxysultaine | | | | |
| Octyl (C₈) alcohol | 0.3-1 | 0.5 | 0.6 | 0.4 |
| Lauryl (C₁₂) alcohol | 0.3-1 | 0.5 | 0.4 | 0.6 |
| Xanthan gum | 0.25-2 | 0.75 | 0.5 | 0.75 |
| Diutan gum | 0.25-2 | 0.75 | 1 | 1 |
| Glucose and/or fructose | 10-15 | 14 | 13 | 15 |
| Water | ≥60 | ≥60 | ≥60 | ≥60 |

*added as separate ingredient in addition to TEA lauryl sulfate

TABLE 6

| Ingredient | Wt. % | Wt. % | Wt. % | Wt. % |
|---|---|---|---|---|
| Biocide | 0.1 | 0.1 | 0.1 | 0.1 |
| Corrosion inhibitor | 0.05 | 0.05 | 0.05 | 0.05 |
| Magnesium sulfate | 1 | 1 | 1.25 | 0.75 |
| Triethanolamine* (TEA) | 5 | 5 | 6 | 5 |
| Glycerin | 0.4 | 0.4 | 0.5 | 0.3 |
| Na Octyl (C₈) sulfate anionic | 3 | 3.5 | 3 | 3.5 |
| surfactant | | | | |
| TEA Lauryl (C₁₂) sulfate anionic | 3.5 | 3 | 2 | 3.5 |
| surfactant | | | | |
| Cocamidopropyl | 4 | 4 | 5 | 3 |
| hydroxysultaine | | | | |
| Decyl (C₁₀) alcohol | — | 0.5 | — | — |
| Lauryl (C₁₂) alcohol | — | 0.5 | 0.5 | — |
| Ethoxylated lauryl alcohol (2 | 1 | — | 0.5 | 1.5 |
| EO) | | | | |
| Xanthan gum | 0.75 | 0.5 | 0.75 | 0.75 |
| Diutan gum | 0.75 | 1 | 0.75 | 1 |
| Glucose and/or fructose | 15 | 13 | 12 | 14 |
| Water | ≥60 | ≥60 | ≥60 | ≥60 |

*added as separate ingredient in addition to TEA lauryl sulfate

The present exemplary aqueous firefighting foam compositions, including the aqueous firefighting foam formulations shown in Tables 1-6, typically have a pH of about 7 to 9. Advantageously, the formulations shown in Tables 1-6 may have a pH of about 7.5 to 8.5. If necessary, a pH-adjusting agent may be added to the composition to achieve the desired pH range.

The present exemplary aqueous firefighting foam compositions, including the exemplary aqueous firefighting foam formulations shown in Tables 1-6, may have a viscosity of about 1,000 to 10,000 cps, in some instances about 1,000 to 5,000 cps and, in some embodiments, may desirably have a viscosity of about 1,000 to 2,500 cps (as determined at room temperature (75° F./24° C.) with a #4 spindle at 30 rpm).

### Method of Producing a Firefighting Foam

The firefighting foam compositions described herein are typically concentrates, which may be mixed with a diluent to form firefighting foam precursor solution, i.e., a use strength composition. The firefighting foam precursor solution may be aerated (e.g., using a nozzle) to produce a firefighting foam including the firefighting foam concentrate and the diluent. Exemplary diluents may include water, such as fresh water, brackish water, sea water, and combinations thereof. In some embodiments, the firefighting foam compositions described above may be 1 vol. %, 3 vol. %, or 6 vol. % concentrate solutions, meaning that the firefighting foam compositions are mixed with 99 vol. %, 97 vol. %, or 94 vol. % diluent, respectively, to form the firefighting foam precursor solution.

In some instances, it has been found that the order of addition of ingredients with appropriate agitation may impact the actual firefighting performance as seen in the UL and EN fire tests. It may be suitable to begin by mixing the sugar component with a substantial amount of water and subsequently preparing a solution or slurry of the polysaccharide thickener in the aqueous sugar solution prior to blending in the remaining components of the foam concentrate. It was found that first preparing an aqueous sugar solution by combining and mixing the sugars (e.g., glucose, fructose, and/or sorbitol) with water may facilitate later dissolution and/or dispersal of biogums/biopolymers (e.g., xanthan gum and/or diutan gum). This can allow the gum to properly hydrate without encapsulating (clumping) upon the addition of the surfactant(s), other optional additives and remaining amounts of water. Surfactants and other optional additives can then be added and the resulting mixture may finally be diluted further with water to decrease the viscosity of the preparation, if desired.

Firefighting foams that were prepared not following this order of component addition may result in polysaccharide bio gums that are encapsulated, but not fully hydrated, which can result in the production of foams that are not satisfactory for fire testing or control. Thus, in some embodiments, the initial formation of an aqueous sugar solution is important in process order and can be used to dissolve/disperse polysaccharide thickener(s) into the foam concentrate before addition of most other ingredients, such as surfactant(s) and/or other additives.

### Method of Fighting a Fire

The firefighting foam compositions described herein may be used to fight a fire and/or to suppress flammable vapors by mixing the firefighting foam compositions with a diluent, aerating the resulting firefighting foam precursor solution to form a firefighting foam, and administering the firefighting foam to a fire or applying the firefighting foam to the surface of a volatile flammable liquid (e.g., gasoline or other flammable hydrocarbon or a flammable polar solvent).

### Illustrative Embodiments

Reference is made to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials, and compositions described herein.

In an exemplary embodiment, the aqueous firefighting composition includes a sugar component; polysaccharide thickener; a surfactant component, which comprises one or more of an anionic surfactant, a zwitterionic surfactant and a nonionic surfactant; and alkanolamine. The aqueous firefighting composition commonly includes at least about 30 wt. % water and is substantially free of any glycol ether, alkylene glycol, and water-soluble polyalkylene glycol solvents. In many instances, the composition contains a total of no more than 0.5 wt. % and, preferably no more than 0.1 wt. % glycol ether, alkylene glycol, and water-soluble polyalkylene glycol solvents. Often, the sugar component comprises monosaccharide sugar and/or sugar alcohol, e.g., at least about 75 wt. % and, in many instances, at least about 85 wt. % monosaccharide sugar and/or sugar alcohol. The surfactant component very often includes a combination of (a) alkyl sulfate anionic surfactant, (b) alkylamidoalkyl hydroxysultaine and (c) an aliphatic alcohol-based component. In some instances, the composition may also include a small amount (e.g., up to about 1 wt. %) of glycerin.

In any embodiments herein, the aqueous firefighting composition includes at least about 5 wt. % of a sugar component; polysaccharide thickener; a surfactant component, which includes aliphatic anionic surfactant, zwitterionic surfactant, and an aliphatic alcohol-based component; at least about 3 wt. % alkanolamine; and at least about 40 wt. % water. The sugar component includes at least about 75 wt. % and, often, at least about 85 wt. % monosaccharide sugar and/or sugar alcohol. Commonly, the aqueous firefighting composition is substantially free of any glycol ether, alkylene glycol, and water-soluble polyalkylene glycol solvents.

In another exemplary embodiment, the aqueous firefighting composition includes about 10 to 20 wt. % of a monosaccharide sugar and/or sugar alcohol; about 0.5 to 3 wt. % polysaccharide thickener, which comprises xanthan gum, rhamsan gum and/or diutan gum; about 5 to 20 wt. % of a surfactant component, which includes alkyl sulfate anionic surfactant, hydroxysultaine zwitterionic surfactant, and an aliphatic alcohol-based component; about 3 to 10 wt. % alkanolamine; and at least about 40 wt. % water. The aqueous firefighting composition typically is substantially free of any glycol ether, alkylene glycol, and water-soluble polyalkylene glycol solvents. In many instances, the composition contains a total of no more than 0.5 wt. % and, often no more than 0.1 wt. % glycol ether, alkylene glycol, and water-soluble polyalkylene glycol solvent.

In another exemplary embodiment, the aqueous firefighting composition includes about 10 to 20 wt. % monosaccharide sugar comprising glucose and/or fructose; about 0.5 to 3 wt. % polysaccharide thickener; about 3 to 10 wt. % alkyl sulfate anionic surfactant; about 1 to 10 wt. % alkylamidopropyl hydroxysultaine surfactant; about 1 to 10 wt. % fatty alcohol-based component; and about 0.3 to 3 wt. % alkanolamine. Commonly, the aqueous firefighting composition includes at least about 40 wt. % water. In most instances, polysaccharide thickener, which comprises xanthan gum, rhamsan gum and/or diutan gum. The aqueous firefighting composition contains a total of no more than 0.5 wt. %, often no more than 0.1 wt. %, glycol ether, alkylene glycol, and water-soluble polyalkylene glycol solvents.

In another exemplary embodiment, the aqueous firefighting composition includes about 10 to 20 wt. % monosaccharide sugar comprising glucose and/or fructose; about 0.5 to 3 wt. % polysaccharide thickener; about 3 to 10 wt. % C₈₋₁₂-alkyl sulfate anionic surfactant; about 1 to 10 wt. % C₈₋₁₄-alkylamidopropyl hydroxysultaine; about 1 to 10 wt. % C₈₋₁₂-fatty alcohol and/or C₁₀₋₁₄-fatty alcohol ethoxylate; about 0.3 to 3 wt. % alkanolamine; and at least about 40 wt. % water. The polysaccharide thickener typically includes xanthan gum, rhamsan gum, and/or diutan gum. In most instances, polysaccharide thickener, which comprises xanthan gum, rhamsan gum and/or diutan gum. The aqueous firefighting composition contains a total of no more than 0.5 wt. %, often no more than 0.1 wt. %, glycol ether, alkylene glycol, and water-soluble polyalkylene glycol solvents.

Another exemplary embodiment provides an aqueous, fluorine-free fire-fighting composition, which includes at least about 10 wt. % of a sugar component; polysaccharide thickener; a surfactant component, which includes one or more of an anionic surfactant, a zwitterionic surfactant, and a nonionic surfactant; at least about 3 wt. % alkanolamine; and at least about 30 wt. % water. The sugar component commonly includes at least about 85 wt. % monosaccharide sugar(s) and has a total of no more than about 10 wt. % disaccharide sugars and oligosaccharides. The composition may desirably be substantially free of any glycol ether, alkylene glycol, and water-soluble polyalkylene glycol solvents. For example, the aqueous firefighting composition may contain a total of no more than 0.5 wt. %, often no more than 0.1 wt. %, glycol ether, alkylene glycol, and water-soluble polyalkylene glycol solvents.

In the exemplary embodiments described above, the aliphatic alcohol-based component may commonly include one or more compounds selected from C₈₋₁₄-aliphatic alcohols and ethoxylates of C₁₀₋₁₄-aliphatic alcohols having an average of no more than about 3 ethylene oxide units.

In the exemplary embodiments described above, the composition commonly includes at least about 5 wt. % and, more commonly, about 10-25 wt. % of the sugar component. For example, the composition commonly includes at least about 5 wt. % of a sugar component including at least about 75 wt. % of one or more of glucose, fructose, mannose, xylose, xylitol, sorbitol, and mannitol. In some instances, a sugar component including at least about 85 wt. % monosaccharide sugar and/or sugar alcohol. In many instances, the sugar component contains a total of no more than about 10 wt. % and, often, no more than about 5 wt. % disaccharide sugars and oligosaccharides.

In the exemplary embodiments described above, the composition commonly includes about 2 to 20 wt. % and, more commonly, about 3 to 15 wt. % of an anionic surfactant. In these compositions, the anionic surfactant may include one or more of an aliphatic sulfate surfactant, an aliphatic sulfonate surfactant, an aliphatic succinate salt, and an aliphatic ether sulfate surfactant. For example, the anionic surfactant may include one or more C₈-C₁₄ alkyl sulfate, C₈-C₁₄ alkyl sulfonate and C₁₀-C₁₄ alkyl ether sulfate. Quite commonly, the anionic surfactant comprises one or more C₈-C₁₄ alkyl sulfates, such as one or more of octyl sulfate salt, decyl sulfate salt and lauryl sulfate salt.

In the exemplary embodiments described above, the composition commonly includes about 2 to 15 wt. % and, more commonly, about 2 to 10 wt. % of a zwitterionic surfactant. The zwitterionic surfactant may suitably include one or more of an aliphatic amidoalkyl betaine, an aliphatic sulfobetaine, an aliphatic amidoalkyl hydroxysultaine, and an aliphatic hydroxysultaine. For example, the zwitterionic surfactant may include one or more of a C₈₋₁₈-alkylamidopropyl hydroxysultaine surfactant, a C₈₋₁₈-alkylamidopropyl betaine surfactant a C₈₋₁₈-alkyl sulfobetaine surfactant and a C₈₋₁₈-alkyl betaine surfactant. Quite often, the zwitterionic surfactant includes an alkyl amidoalkyl hydroxysultaine, such as one or more C₈-C₁₄ alkyl amidopropyl hydroxysultaine, e.g., cocamidopropyl hydroxysultaine.

In the exemplary embodiments described above, the composition commonly includes about 2 to 15 wt. % and, more commonly, about 3 to 10 wt. % of an aliphatic alcohol-based surfactant. In some instances, the aliphatic alcohol-based component may include at least two linear C₈₋₁₄-aliphatic alcohols, e.g., the aliphatic alcohol-based component may include capryl alcohol and lauryl alcohol in a weight ratio ranging from 1:5 to 5:1 and, often, in a weight ratio ranging from 1:2 to 2:1. In some instances, the aliphatic alcohol-based component may include an ethoxylate of a linear C₁₂- or C₁₄-aliphatic alcohol having an average of no more than about 6 and, more commonly, no more than about 4 ethylene oxide units. In some instances, the aliphatic alcohol-based component may include a lauryl alcohol ethoxylate having an average of no more than about 5 ethylene oxide units and/or a myristyl alcohol ethoxylate having an average of no more than about 5 ethylene oxide units. In some instances, the aliphatic alcohol-based component may include lauryl alcohol and a lauryl alcohol ethoxylate having an average of no more than about 5 ethylene oxide units. In some instances, the aliphatic alcohol-based component may include an ethoxylate of a linear C₁₀₋₁₄-aliphatic alcohol having no more than about 3 ethylene oxide units.

In the exemplary embodiments described above, the composition commonly includes the composition includes about 0.1 to 5 wt. % and, more commonly, about 0.5 to 3 wt. % of a polysaccharide thickener. Suitable polysaccharide thickeners include one or more of xanthan gum, diutan gum, rhamsan gum, welan, gellan gum, guar gum, konjac gum, tarn gum, and methylcellulose. For example, the polysaccharide thickener comprises one or more of xanthan gum, diutan gum, and rhamsan gum.

In the exemplary embodiments described above, the composition commonly includes about 2 to 15 wt. % and, more commonly, about 3 to 10 wt. % of an alkanolamine. Examples of suitable alkanolamines include monoalkanolamines, dialkanolamines, and/or trialkanolamines. The alkanolamine may include monoethanolamine, diethanolamine, diisopropanolamine, and/or triethanolamine. Quite commonly, the alkanolamine includes triethanolamine.

In the exemplary embodiments described above, the composition may also include a divalent metal salt, such a magnesium salt. For example, the composition commonly includes about 0.1 to 5 wt. % of a divalent metal salt, e.g., a magnesium salt, such as magnesium sulfate and/or magnesium acetate.

In the exemplary embodiments described above, the composition may also include one or more of a chelator, a buffer, a corrosion inhibitor, and a preservative.

In the exemplary embodiments described above, the composition commonly is substantially free of any glycol ether, alkylene glycol, and water-soluble polyalkylene glycol solvents. In most instances, the composition contains a total of no more than 0.5 wt. % and, often, no more than 0.1 wt. % glycol ether, alkylene glycol, and water-soluble polyalkylene glycol solvents.

In the exemplary embodiments described above, the composition commonly has a pH of about 7 to 9.

In the exemplary embodiments described above, the composition commonly often contains a total of no more than about 0.1 wt. % fluorinated additives. In some instances, the composition may have a total concentration of fluorine atoms on a weight percentage basis of no more than about 1 ppm F.

In the exemplary embodiments described above including a polysaccharide thicker may benefit from including one or more of xanthan gum, diutan gum, rhamsan gum, welan, gellan gum, guar gum, konjac gum, tarn gum, and methylcellulose. Those exemplary embodiments including an zwitterionic surfactant may benefit from including one or more of a C₈₋₁₄-alkylamidopropyl hydroxysultaine surfactant, a C₈₋₁₄-alkylamidopropyl betaine surfactant, a C₈₋₁₄-alkyl sulfobetaine surfactant and a C₈₋₁₄-alkyl betaine surfactant.

In another exemplary embodiment, a firefighting foam may be created by mixing any of the preceding firefighting foam composition and a diluent. The aqueous diluent may be selected from the group consisting of fresh water, brackish water, sea water, and combinations thereof.

Another exemplary embodiment comprises a method of forming a firefighting foam in which the method includes the steps of mixing the firefighting foam composition of any of the preceding illustrative embodiments with an aqueous diluent to form a foam precursor solution, and aerating the foam precursor solution to form the firefighting foam. In such a method the aqueous diluent may be selected from the group consisting of fresh water, brackish water, sea water, and combinations thereof.

Another exemplary embodiment is a method of fighting a fire, where the method includes the steps of administering the firefighting foam described in the preceding exemplary embodiments to the fire.

In the exemplary embodiments described above, it may be advantageous to provide an aqueous firefighting foam composition, which does not contain any protein hydrolysate. In some instances, it may be advantageous to provide an aqueous firefighting foam composition, which does not contain any synthetic polymer or copolymer. In some instances, it may be advantageous to provide an aqueous firefighting foam composition, which does not contain any non-biopolymeric thickening agent.
Para. 1. An aqueous fire-fighting composition comprising: a sugar component; a polysaccharide thickener; a surfactant component comprising one or more of an anionic surfactant, a zwitterionic surfactant, and a nonionic surfactant; an alkanolamine; and at least about 30 wt. % water; wherein: the aqueous fire-fighting composition is substantially free of any glycol ether, alkylene glycol, and water-soluble polyalkylene glycol solvents.
Para. 2. The aqueous fire-fighting composition of Para. 1, wherein the sugar component comprises monosaccharide sugar and/or sugar alcohol.
Para. 3. The aqueous fire-fighting composition of Para. 1 or 2, wherein the surfactant component comprises an alkyl sulfate anionic surfactant, an alkylamidoalkyl hydroxysultaine, and an aliphatic alcohol-based component.
Para. 4. The aqueous fire-fighting composition of any one of Paras. 1-3, wherein the composition further comprises glycerin.
Para. 5. An aqueous fire-fighting composition comprising: at least about 5 wt. % of a sugar component comprising at least about 75 wt. % of a monosaccharide sugar, a sugar alcohol, or a combination thereof; a polysaccharide thickener; a surfactant component comprising an aliphatic anionic surfactant, a zwitterionic surfactant, and an aliphatic alcohol-based component; at least about 3 wt. % of an alkanolamine; and at least about 40 wt. % water; wherein the aqueous fire-fighting composition is substantially free of any glycol ether, alkylene glycol, and water-soluble polyalkylene glycol solvents.
Para. 6. The aqueous fire-fighting composition of Para. 5, wherein the aliphatic alcohol-based component comprises one or more compounds selected from the group consisting of C₈₋₁₄-aliphatic alcohols and ethoxylates of C₁₀₋₁₄-aliphatic alcohols having an average of no more than about 3 ethylene oxide units.
Para. 7. The aqueous fire-fighting composition of any one of Paras. 1-6 comprising at least about 5 wt. % of the sugar component.
Para. 8. The aqueous fire-fighting composition of Para. 7, wherein the sugar component comprises at least about 85 wt. % of the monosaccharide sugar, the sugar alcohol, or a combination thereof.
Para. 9. The aqueous fire-fighting composition of Para. 7, wherein the sugar component comprises at least about 75 wt. % of one or more of glucose, fructose, mannose, xylose, xylitol, sorbitol, and mannitol.
Para. 10. The aqueous fire-fighting composition of Para. 7, wherein the sugar component contains a total of no more than about 10 wt. % disaccharide sugars and oligosaccharides.
Para. 11. The aqueous fire-fighting composition of any one of Paras. 1-10 comprising about 2 to 20 wt. % of the anionic surfactant.
Para. 12. The aqueous fire-fighting composition of Para. 11, wherein the anionic surfactant comprises one or more of an aliphatic sulfate surfactant, an aliphatic sulfonate surfactant, an aliphatic succinate salt, or an aliphatic ether sulfate surfactant.
Para. 13. The aqueous fire-fighting composition of Para. 11 or 12, wherein the anionic surfactant comprises one or more of a C₈-C₁₄ alkyl sulfate, a C₈-C₁₄ alkyl sulfonate and a C₁₀-C₁₄ alkyl ether sulfate.
Para. 14. The aqueous fire-fighting composition of any one of Paras. 11-13, wherein the anionic surfactant comprises one or more C₈-C₁₄ alkyl sulfates.
Para. 15. The aqueous fire-fighting composition of any one of Paras. 11-14, wherein the anionic surfactant comprises one or more of octyl sulfate salt, decyl sulfate salt, and lauryl sulfate salt.
Para. 16. The aqueous fire-fighting composition of any one of Paras. 11-15, wherein the composition comprises about 2 to 15 wt. % of the zwitterionic surfactant.
Para. 17. The aqueous fire-fighting composition of any one of Paras. 11-16, wherein the zwitterionic surfactant comprises one or more of an aliphatic amidoalkyl betaine, an aliphatic sulfobetaine, an aliphatic amidoalkyl hydroxysultaine, and an aliphatic hydroxysultaine.
Para. 18. The aqueous fire-fighting composition of any one of Paras. 11-17, wherein the zwitterionic surfactant comprises one or more of a C₈₋₁₈-alkylamidopropyl hydroxysultaine surfactant, a C₈₋₁₈-alkylamidopropyl betaine surfactant, a C₈₋₁₈-alkyl sulfobetaine surfactant, and a C₈₋₁₈-alkyl betaine surfactant.
Para. 19. The aqueous fire-fighting composition of any one of Paras. 11-18, wherein the zwitterionic surfactant comprises alkyl amidoalkyl hydroxysultaine.
Para. 20. The aqueous fire-fighting composition of any one of Paras. 11-19, wherein the zwitterionic surfactant comprises one or more C₈-C₁₄ alkyl amidopropyl hydroxysultaine.
Para. 21. The aqueous fire-fighting composition of any one of Paras. 16-20, wherein the zwitterionic surfactant comprises cocamidopropyl hydroxysultaine.
Para. 22. The aqueous fire-fighting composition of any of Paras. 1 to 21, wherein the composition comprises about 2 to 15 wt. % of an aliphatic alcohol-based surfactant.
Para. 23. The aqueous fire-fighting composition of Para. 22, wherein the aliphatic alcohol-based component comprises at least two linear C₈₋₁₄-aliphatic alcohols.
Para. 24. The aqueous fire-fighting composition of Para. 22, wherein the aliphatic alcohol-based component comprises capryl alcohol and lauryl alcohol in a weight ratio ranging from 1:5 to 5:1.
Para. 25. The aqueous fire-fighting composition of Para. 22, wherein the aliphatic alcohol-based component comprises an ethoxylate of a linear C₁₂- or C₁₄-aliphatic alcohol having an average of no more than about 6 ethylene oxide units.
Para. 26. The aqueous fire-fighting composition of Para. 22, wherein the aliphatic alcohol-based component comprises a lauryl alcohol ethoxylate having an average of no more than about 5 ethylene oxide units.
Para. 27. The aqueous fire-fighting composition of Para. 22, wherein the aliphatic alcohol-based component comprises a myristyl alcohol ethoxylate having an average of no more than about 5 ethylene oxide units.
Para. 28. The aqueous fire-fighting composition of Para. 22, wherein the aliphatic alcohol-based component comprises lauryl alcohol and a lauryl alcohol ethoxylate having an average of no more than about 5 ethylene oxide units.
Para. 29. The aqueous fire-fighting composition of Para. 22, wherein the aliphatic alcohol-based component comprises an ethoxylate of a linear C₁₀₋₁₄-aliphatic alcohol having no more than about 3 ethylene oxide units.
Para. 30. The aqueous fire-fighting composition of any one of Paras. 1-29, wherein the composition includes about 0.1 to 5 wt. % of the polysaccharide thickener.
Para. 31. The aqueous fire-fighting composition of Para. 30, wherein the polysaccharide thickener comprises one or more of xanthan gum, diutan gum, rhamsan gum, welan, gellan gum, guar gum, konjac gum, tarn gum, and methylcellulose.
Para. 32. The aqueous fire-fighting composition of Para. 30, wherein the polysaccharide thickener comprises one or more of xanthan gum, diutan gum, and rhamsan gum.
Para. 33. The aqueous fire-fighting composition of any one of Paras. 1-32, wherein the aqueous fire-fighting composition comprises about 2 to 15 wt. % of an alkanolamine.
Para. 34. The aqueous fire-fighting composition of Para. 33, wherein the alkanolamine comprises monoalkanolamine, dialkanolamine, trialkanolamine, or a mixture of any two or more thereof.
Para. 35. The aqueous fire-fighting composition of Para. 33, wherein the alkanolamine comprises monoethanolamine, diethanolamine, diisopropanolamine, triethanolamine, or a mixture of any two or more thereof.
Para. 36. The aqueous fire-fighting composition of Para. 33, wherein the alkanolamine comprises triethanolamine.
Para. 37. The aqueous fire-fighting composition of any one of Paras. 1-36, wherein the composition contains a total of no more than 0.5 wt. % glycol ether, alkylene glycol, and water-soluble polyalkylene glycol solvents.
Para. 38. An aqueous fire-fighting composition comprising: about 10 to 20 wt. % of a sugar component comprising a monosaccharide sugar, a sugar alcohol, or a mixture of any two or more thereof; about 0.5 to 3 wt. % polysaccharide thickener, which comprises xanthan gum, rhamsan gum, diutan gum, or a mixture of any two or more thereof; about 5 to 20 wt. % of a surfactant component comprising an alkyl sulfate anionic surfactant, a hydroxysultaine zwitterionic surfactant, and an aliphatic alcohol-based component; about 3 to 10 wt. % of an alkanolamine; and at least about 40 wt. % water; wherein the composition contains a total of no more than 0.5 wt. % glycol ether, alkylene glycol, and water-soluble polyalkylene glycol solvent.
Para. 39. The aqueous fire-fighting composition of Para. 38, wherein the sugar component contains at least about 75 wt. % monosaccharide sugar.
Para. 40. The aqueous fire-fighting composition of Para. 38 or 39, wherein the sugar component contains a total of no more than about 10 wt. % disaccharide sugars and oligosaccharides.
Para. 41. The aqueous fire-fighting composition of any one of Paras. 38-40, wherein the sugar component contains a total of no more than about 10 wt. % disaccharide sugars and oligosaccharides (as a percentage of the total amount of sugars and oligosaccharides).
Para. 42. An aqueous fire-fighting composition comprising: about 10 to 20 wt. % monosaccharide sugar comprising glucose, fructose, or a mixture thereof; about 0.5 to 3 wt. % polysaccharide thickener comprising xanthan gum, rhamsan gum, diutan gum, or a mixture of any two or more thereof; about 3 to 10 wt. % alkyl sulfate anionic surfactant; about 1 to 10 wt. % alkylamidopropyl hydroxysultaine surfactant; about 1 to 10 wt. % fatty alcohol-based component; about 0.3 to 3 wt. % alkanolamine; and at least about 40 wt. % water; wherein the composition contains a total of no more than 0.5 wt. % glycol ether, alkylene glycol, and water-soluble polyalkylene glycol solvents.
Para. 43. A fluorine-free aqueous fire-fighting composition comprising: about 10 to 20 wt. % monosaccharide sugar comprising glucose and/or fructose; about 0.5 to 3 wt. % polysaccharide thickener comprising xanthan gum, rhamsan gum, diutan gum, or a mixture of any two or more thereof; about 3 to 10 wt. % C₈₋₁₂-alkyl sulfate anionic surfactant; about 1 to 10 wt. % C₈₋₁₄-alkylamidopropyl hydroxysultaine; about 1 to 10 wt. % C₈₋₁₂-fatty alcohol and/or C₁₀₋₁₄-fatty alcohol ethoxylate; about 0.3 to 3 wt. % alkanolamine; and at least about 40 wt. % water; wherein the composition contains a total of no more than 0.5 wt. % glycol ether, alkylene glycol, and water-soluble polyalkylene glycol solvents.
Para. 44. The aqueous fire-fighting composition of Para. 43, wherein the surfactant system comprises cocamidopropyl hydroxysultaine and at least one of an octyl sulfate, a lauryl sulfate, and a decyl sulfate.
Para. 45. The aqueous fire-fighting composition of any one of Paras. 1-44, further comprising a divalent metal salt.
Para. 46. The composition of Para. 45, wherein the divalent metal salt comprises a magnesium salt.
Para. 47. The aqueous fire-fighting composition of Para. 45, wherein the composition comprises about 0.1 to 5 wt. % of a magnesium salt.
Para. 48. The aqueous fire-fighting composition of any one of Paras. 1-47, wherein the composition further comprises one or more of a chelator, a buffer, a corrosion inhibitor, and a preservative.
Para. 49. The aqueous fire-fighting composition of any one of Paras. 1-48, wherein the composition has a pH of about 7 to 9.
Para. 50. The aqueous fire-fighting composition of any one of Paras. 1-49, wherein the composition contains a total of no more than about 0.1 wt. % fluorinated additives.
Para. 51. The aqueous fire-fighting composition of any one of Paras. 1-49, wherein the composition has a total concentration of fluorine atoms on a weight percentage basis of no more than about 1 ppm F.
Para. 52. The aqueous fire-fighting composition of any one of Paras. 1-51, wherein the composition does not contain any protein hydrolysate.
Para. 53. The aqueous fire-fighting composition of any one of Paras. 1-52 further comprising a hydrophilic synthetic polymer or copolymer.
Para. 54. The aqueous fire-fighting composition of any one of Paras. 1-53 further comprising about 0.2 to 3 wt. % magnesium sulfate, about 0.05 to 0.2 wt. % preservative, and about 0.01 to 0.1 wt. % tolyltriazole.
Para. 55. A method of forming a firefighting foam, the method comprising: mixing the aqueous firefighting foam composition of any one of Paras. 1-54 with an aqueous diluent to form a foam precursor solution; and aerating the foam precursor solution to form the firefighting foam.
Para. 56. The method of Para. 55, wherein the aqueous diluent is selected from the group consisting of fresh water, brackish water, sea water, and combinations thereof.
Para. 57. A firefighting foam comprising the firefighting foam composition of any of Paras. 1-54 and an aqueous diluent.
Para. 58. A method of fighting a fire, the method comprising applying the firefighting foam of Para. 57 to the fire.
Para. 59. An aqueous, fluorine-free fire-fighting composition comprising: at least about 10 wt. % of a sugar component, which comprises at least about 85 wt. % monosaccharide sugar(s) and a total of no more than about 10 wt. % disaccharide sugars and oligosaccharides; polysaccharide thickener; a surfactant component, which comprises one or more of an anionic surfactant, a zwitterionic surfactant, and a nonionic surfactant; at least about 3 wt. % alkanolamine; and at least about 30 wt. % water; wherein the composition is substantially free of any glycol ether, alkylene glycol and water-soluble polyalkylene glycol solvents.

While certain embodiments have been illustrated and described, it should be understood that changes and modifications can be made therein in accordance with ordinary skill in the art without departing from the technology in its broader aspects.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1-4. (canceled)

5. An aqueous fire-fighting composition comprising:
at least about 5 wt. % of a sugar component comprising at least about 75 wt. % of a monosaccharide sugar, a sugar alcohol, or a combination thereof;
a polysaccharide thickener;
a surfactant component comprising an aliphatic anionic surfactant, a zwitterionic surfactant, and an aliphatic alcohol-based component;
at least about 3 wt. % of an alkanolamine; and
at least about 40 wt. % water;
wherein the aqueous fire-fighting composition is substantially free of any glycol ether, alkylene glycol, and water-soluble polyalkylene glycol solvents.

6. The aqueous fire-fighting composition of claim 5, wherein the aliphatic alcohol-based component comprises one or more compounds selected from the group consisting of C₈₋₁₄-aliphatic alcohols and ethoxylates of C₁₀₋₁₄-aliphatic alcohols having an average of no more than about 3 ethylene oxide units.

7. The aqueous fire-fighting composition of claim 5, wherein the fire-fighting composition comprises at least about 5 wt. % of the sugar component.

8. (canceled)

9. The aqueous fire-fighting composition of claim 7, wherein the sugar component comprises at least about 75 wt. % of one or more of glucose, fructose, mannose, xylose, xylitol, sorbitol, and mannitol.

10. The aqueous fire-fighting composition of claim 7, wherein the sugar component contains a total of no more than about 10 wt. % disaccharide sugars and oligosaccharides.

11. The aqueous fire-fighting composition of claim 5, wherein the fire-fighting composition comprises about 2 to 20 wt. % of the anionic surfactant.

12-14. (canceled)

15. The aqueous fire-fighting composition of claim 11, wherein the anionic surfactant comprises one or more of octyl sulfate salt, decyl sulfate salt, and lauryl sulfate salt.

16. The aqueous fire-fighting composition of claim 5, wherein the composition comprises about 2 to 15 wt. % of the zwitterionic surfactant.

17. (canceled)

18. The aqueous fire-fighting composition of claim 16, wherein the zwitterionic surfactant comprises one or more of a C₈₋₁₈-alkylamidopropyl hydroxysultaine surfactant, a C₈₋₁₈-alkylamidopropyl betaine surfactant, a C₈₋₁₈-alkyl sulfobetaine surfactant, and a C₈₋₁₈-alkyl betaine surfactant.

19. (canceled)

20. The aqueous fire-fighting composition of claim 16, wherein the zwitterionic surfactant comprises one or more C₈-C₁₄ alkyl amidopropyl hydroxysultaine.

21. (canceled)

22. The aqueous fire-fighting composition of claim 5, wherein the composition comprises about 2 to 15 wt. % of an aliphatic alcohol-based surfactant.

23. (canceled)

24. The aqueous fire-fighting composition of claim 22, wherein the aliphatic alcohol-based component comprises capryl alcohol and lauryl alcohol in a weight ratio ranging from 1:5 to 5:1.

25. The aqueous fire-fighting composition of claim 22, wherein the aliphatic alcohol-based component comprises an ethoxylate of a linear C₁₂- or C₁₄-aliphatic alcohol having an average of no more than about 6 ethylene oxide units.

26. (canceled)

27. The aqueous fire-fighting composition of claim 22, wherein the aliphatic alcohol-based component comprises a myristyl alcohol ethoxylate having an average of no more than about 5 ethylene oxide units.

28. The aqueous fire-fighting composition of claim 22, wherein the aliphatic alcohol-based component comprises lauryl alcohol and a lauryl alcohol ethoxylate having an average of no more than about 5 ethylene oxide units.

29. The aqueous fire-fighting composition of claim 22, wherein the aliphatic alcohol-based component comprises an ethoxylate of a linear C₁₀₋₁₄-aliphatic alcohol having no more than about 3 ethylene oxide units.

30. The aqueous fire-fighting composition of claim 5, wherein the composition includes about 0.1 to 5 wt. % of the polysaccharide thickener.

31. The aqueous fire-fighting composition of claim 30, wherein the polysaccharide thickener comprises one or more of xanthan gum, diutan gum, rhamsan gum, welan, gellan gum, guar gum, konjac gum, tarn gum, and methylcellulose.

32-34. (canceled)

35. The aqueous fire-fighting composition of claim 5, wherein the alkanolamine comprises monoethanolamine, diethanolamine, diisopropanolamine, triethanolamine, or a mixture of any two or more thereof.

36-54. (canceled)

55. A method of forming a firefighting foam, the method comprising:
mixing the aqueous firefighting foam composition of claim 5 with an aqueous diluent to form a foam precursor solution; and
aerating the foam precursor solution to form the firefighting foam.

56-59. (canceled)
